(19) United States
(12) Patent Application Publication
(10) Pub. No.: US 2025/0103125 A1
(43) Pub. Date: Mar. 27, 2025

(54) IOT DEVICE POWER DRAW REDUCTION INTELLIGENT POWER MANAGEMENT

(71) Applicant: INTERNATIONAL BUSINESS MACHINES CORPORATION, ARMONK, NY (US)

(72) Inventors: Zachary A. Silverstein, Georgetown, TX (US); Jeremy R. Fox, Georgetown, TX (US); Mauro Marzorati, Lutz, FL (US); Logan Bailey, Atlanta, GA (US)

(21) Appl. No.: 18/473,330

(22) Filed: Sep. 25, 2023

(51) Int. Cl. G06F 1/3231; G06N 3/044; G16Y 20/10; G16Y 40/10; G16Y 40/20; G16Y 40/35

(52) U.S. Cl. CPC G06F 1/3231; G06N 3/044; G16Y 20/10; G16Y 40/10; G16Y 40/20; G16Y 40/35

(57) ABSTRACT

According to at least one embodiment, a method, a computer system, and a computer program product for managing power draw reduction of one or more IoT devices is provided. The present invention may include determining, continuously, an individual's micro-location to dynamically pinpoint a location of the individual in an indoor location using one or more wearable IoT devices; determining if the individual has entered a new area of the indoor location; upon determining that the individual has entered the new area of the indoor location, analyzing the individual's current micro-location, device interaction history, and device exception list; providing a command to one or more IoT devices in one or more non-individually present areas to manage electricity flow to the IoT devices; and providing a command to one or more IoT devices in the newly entered area to manage electricity flow to the IoT devices.

### BACKGROUND

The present invention relates generally to the field of energy management systems, in particular, to energy management using Internet of Things (“IoT”) devices.

Limiting the consumption of electricity can play a meaningful role in reducing the energy and climate impact on the environment. Additionally, limiting the consumption of electricity can be important in reducing one's utility bills as well as conserving power in situations where its supply is limited, such as when a power outage occurs and a backup grid, for example, a generator, is used to supply electricity to an indoor location. Thus, managing the distribution of electricity remains a priority. One potential method of conserving electricity involves situations where electricity is being provided to devices that are not being used, resulting in phantom power draw, also known as standby power.

### SUMMARY

Embodiments of a method, a computer system, and a computer program product for managing power draw reduction of IoT devices are described. According to one embodiment of the present invention, a method, computer system, and computer program product for managing the power draw of IoT devices based on an individual's micro-location in an indoor location is provided. The present invention may include determining, continuously, an individual's micro-location to dynamically pinpoint a location of the individual in an indoor location using one or more wearable IoT devices; determining if the individual has entered a new area of the indoor location; upon determining that the individual has entered the new area of the indoor location, analyzing the individual's current micro-location, device interaction history, and device exception list; providing one or more commands to one or more IoT devices in one or more non-individually present areas to manage electricity flow to the one or more IoT devices; and providing one or more commands to one or more IoT devices in the newly entered area of the indoor location to manage electricity flow to the one or more IoT devices.

### BRIEF DESCRIPTION OF THE SEVERAL VIEWS OF THE DRAWINGS

These and other objects, features, and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment;

FIG. 2 is an operational flowchart illustrating an IoT device power draw reduction determination process according to at least one embodiment;

FIG. 3 is an illustration of a power draw reduction process based on an individual's original micro-location in an indoor location according to at least one embodiment;

FIG. 4 is an illustration of an updated power draw reduction process based on the individual's change in micro-location in the indoor location according to at least one embodiment; and

FIG. 5 is a system diagram illustrating an exemplary program environment of an implementation of an IoT device power draw reduction determination process according to at least one embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

Embodiments of the present invention relate generally to the field of energy management systems, in particular, to energy management using Internet of Things devices. The following described exemplary embodiments provide a method, program product, and system to, among other things, dynamically control and limit the electricity provided to devices in an indoor location based, primarily, on the micro-location of an individual. A micro-location can comprise an individual's placement in an indoor location pinpointed to within a few inches or feet. Therefore, the present embodiment has the capacity to improve computers and energy management systems by continuously receiving logs and micro-location from an individual's device(s), providing power to devices in an area of an indoor location based on the individual's micro-location, as well as power certain devices based on the needed or expected usage of the devices.

As previously described, limiting the consumption of electricity can play a meaningful role in reducing the energy and climate impact on the environment. Additionally, limiting the consumption of electricity can be important in reducing one's utility bills as well as conserving power in situations where its supply is limited, such as when a power outage occurs and a backup grid, for example, a generator, is used to supply electricity to an indoor location. Thus, managing the distribution of electricity remains a priority. One potential method of conserving electricity involves situations where electricity is being provided to devices that are not being used, resulting in phantom power draw, also known as standby power. For example, limiting phantom power draw can be particularly important when power is out for an unknown period and an indoor location relies on a backup grid to provide power. In such a situation, it is extremely important to limit all non-critical power draws because phantom power may pull a significant amount of limited power. Current methods attempt to improve energy management systems by providing real-time information about electrical usage in a location, such as a building. However, this method only comprises the exchange of usage metrics and cannot initiate, either automated or through a user's inputs, any changes to the draw of electricity by one or more IoT devices. Additionally, current methods attempt to improve energy management systems using microcontrollers and a sandboxed software plug-in. However, the use of such hardware/software does not dynamically control the flow of electricity to one or more areas in an indoor location based on a user's change in location. Therefore, it may be likely that on a day-to-day basis, an individual wastes electricity on devices that are either not being used at all or only for a limited period, but still are plugged in and draw power.

Thus, embodiments of the present invention may provide advantages including, but not limited to, dynamically mitigating power usage due to phantom power drawn from devices in areas of an indoor location, such as a house or apartment, based on an individual's micro-location in the indoor location and the individual's device exception list and device interaction history. A device exception list may comprise one or more exception devices, which can be devices that the individual has designated to always provide power to, or to provide power for a certain amount of time. Additionally, an individual's interaction history may comprise IoT loggings indicating an individual's presence, such as event data comprising the individual's interaction with a device. The present invention does not require that all advantages need to be incorporated into every embodiment of the invention.

According to at least one embodiment, an individual's micro-location can be determined using one or more wearable IoT devices to dynamically pinpoint a location of the individual in an indoor location. The individual's location data from the wearable IoT devices can be continuously received as the individual moves around the indoor location. The incoming location data can be analyzed using the micro-location module to dynamically determine the individual's micro-location in the indoor location. According to at least one embodiment, whether the individual has entered a new area of the indoor location can be determined. An area of the indoor location may comprise a section/space/zone of an indoor location, such as a room. The micro-locations comprising each area of the indoor location can be determined by learning the layout of an indoor location through room mapping techniques, such as predefining a room, or by using a camera-based mapping system, for example, using augmented reality, 3D scanners, and/or cameras, to combine images with data provided through various sensors to build a layout of the indoor location. Additionally, the location of the IoT devices comprised within each area of the indoor location may be determined based on the micro-locations of the devices or by the individual indicating what room a device is in through a GUI. Data comprising the micro-location of a device may be received from a device in the same way as data comprising the micro-location of an individual from the one or more wearable IoT devices is received.

According to at least one embodiment, upon determining that the individual has entered a new area of the indoor location, the individual's current micro-location, the individual's device interaction history, and the individual's device exception list, can be analyzed using trained machine learning models, such as an artificial neural network, and more specifically a recurrent neural network (“RNN”). By analyzing the three sets of data, the devices located within the newly entered area of the indoor location that need to be provided with electricity, the devices located in the non-individual present areas of the indoor location that no longer need to be provided with electricity, and the devices to flag as bypassing shut-off commands based on the individual's device exception list and the individual's significant interaction history, can be determined. Non-individually present areas may comprise areas in the indoor location in which the individual is not located at a current time.

According to at least one embodiment, one or more commands to one or more IoT devices, to manage the electricity flow to the one or more IoT devices, in one or more areas of the indoor location can be provided by a computer. The flow of electricity in each area of the indoor location can be controlled by connecting the computer to one or more intermediary devices, such as an intelligent circuit breaker or a smart power strip, in the indoor location. A command may comprise either a “power-off” or a “power-on” signal to one or more intermediary devices. Commands can be sent by the computer to the intermediary device via one or more cloud-based services, such as the API of the intermediary device. IoT devices can be connected to an intermediary device through electric wires. The flow of electricity to an IoT device can be shut off by providing an auto-shut command to an intermediary device to which the IoT device is connected. The flow of electricity to an IoT device can be turned on by providing an auto-turn-on command to an intermediary device to which the IoT device is connected.

According to at least one other embodiment, the one or more commands to the one or more IoT devices in the indoor location, to manage the flow of electricity to the one or more IoT devices, may be based on one or more individuals' current micro-location, one or more individuals' device interaction history, and one or more individuals' device exception list.

The present invention may be a system, a method, and/or a computer program product at any possible technical detail level of integration. The computer program product may include a computer-readable storage medium (or media) having computer-readable program instructions thereon for causing a processor to carry out aspects of the present invention.

Various aspects of the present disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

The following described exemplary embodiments provide a system, method, and program product for determining, continuously, an individual's micro-location to dynamically pinpoint a location of the individual in an indoor location using one or more wearable IoT devices, determining if the individual entered a new area of the indoor location, upon determining that the individual has entered the new area of the indoor location, analyzing the individual's current micro-location, device interaction history, and device exception list, providing one or more commands to one or more IoT devices in one or more non-individually present areas to manage electricity flow to the IoT devices, and providing one or more commands to one or more IoT devices the newly entered area of the indoor location to manage electricity flow to the IoT devices.

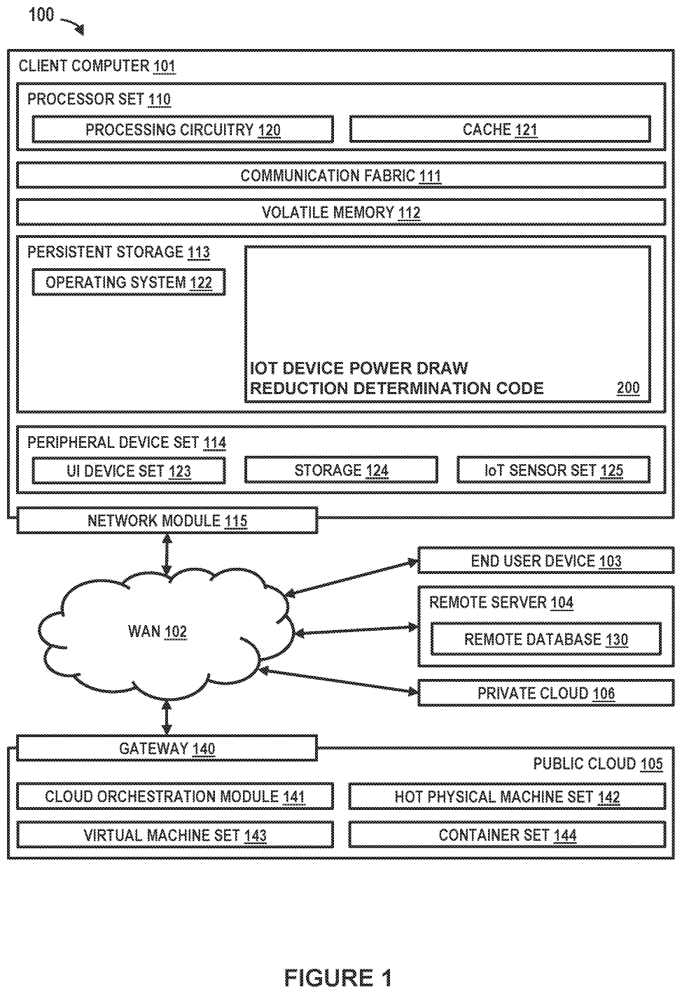

Beginning now with FIG. 1, an exemplary networked computer environment 100 is depicted, according to at least one embodiment. Computing environment 100 contains an example of an environment for the execution of at least some of the computer code involved in performing the inventive methods, such as IoT device power draw reduction determination code 200, “the program”. In addition to code block 200, computing environment 100 includes, for example, computer 101, wide area network (WAN) 102, end-user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and code block 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer, or any other form of computer or mobile device now known or to be developed in the future that is capable of running an algorithm, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated. Additionally, computer 101 may comprise a dependent device.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off-chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby affect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in code block 200, in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports, and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read-only memory (ROM), but typically at least a portion of the persistent storage allows writing of data, deletion of data, and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in code block 200, typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), beacon connections (for example, location-based services (LBS)), virtual beacon connections, connections made through local area communication networks and even connections made through wide area networks such as the internet. Additionally, peripheral device set 114 may comprise intermediary devices, such as smart power strip(s) and/or intelligent circuit breakers. Also, peripheral device set 114 may comprise a centralized device. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as application-specific integrated circuits (“ASICs”), copper transmission cables, optical transmission fibers, wireless transmission, routers, firewalls, switches, gateway computers, and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer, and so on. Additionally, EUD 103 may comprise a guardian device.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs, and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community, or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The database 130 may be a digital repository capable of data storage and data retrieval. The database 130 can be present in the remote server 104 and/or any other location in the network 102. The database 130 can an individual's device interaction history as well as an individual's list of exception devices. Additionally, the database 130 may comprise virtual 3D models of an indoor location. Also, the database 130 can comprise machine learning models, such as the RNN, as well as the training data used to train the machine learning models.

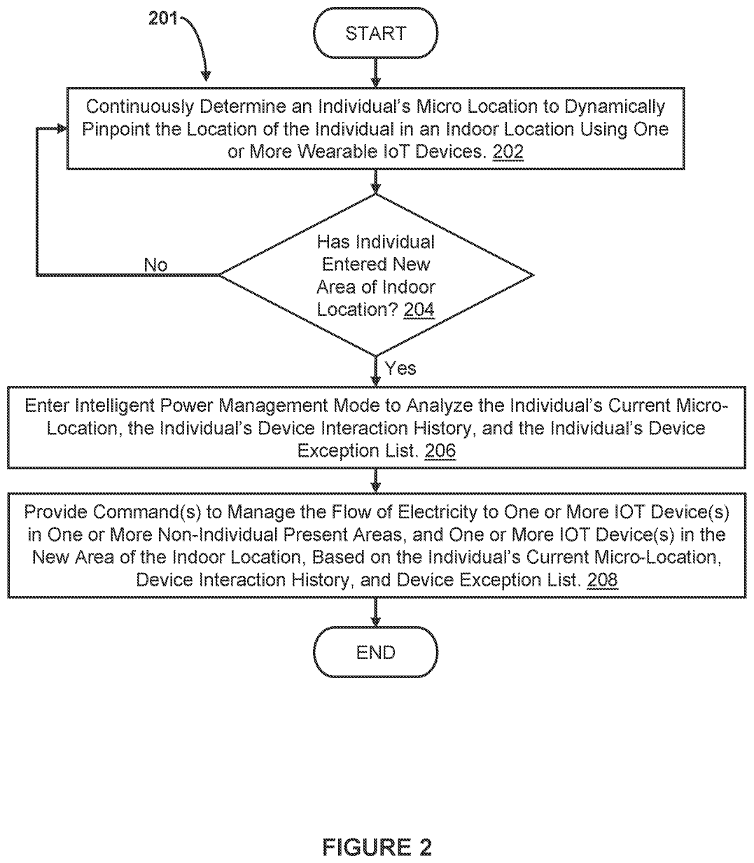

According to the present embodiment, the IoT device power draw reduction determination code 200, “the program”, may be a program capable of continuously determining an individual's micro-location to dynamically pinpoint the location of the individual, determining if an individual entered a new area of an indoor location, entering an intelligent power management mode to analyze the individual's current micro-location, individual's device interaction history, and the individual's device exception list, and providing command(s) to manage the flow of electricity to one or more IoT devices in one or more non-individual present areas based on the individual's current micro-location, device interaction history, and device exception list. The program 200 may be located on client computing device 101 or remote server 104 or on any other device located within network 102. Furthermore, the program 200 may be distributed in its operation over multiple devices, such as client computing device 101 and remote server 104. The IoT device power draw reduction determination method is explained in further detail below with respect to FIG. 2.

FIG. 2 is an operational flowchart illustrating an IoT device power draw reduction determination process 201 according to at least one embodiment. At 202, the program 200 continuously determines an individual's micro-location to dynamically pinpoint the precise location of the individual in an indoor location, such as an apartment, house, or office, using one or more wearable IoT devices 123. As previously stated, a micro-location can comprise an individual's or device's 114 placement in an indoor location, pinpointed to within a few inches or feet. The program 200 may receive data comprising the micro-location of an individual from one or more wearable IoT devices 123, such as a smart watch, through Bluetooth connections, NFC connections, beacon connections, and/or virtual beacon connections. The wearable IoT device(s) 123 may collect real-time data on an individual's precise location, such as the latitude and longitude of the individual. An individual may comprise any person using program 200 on their computer 101 and who has Bluetooth enabled on the computer 101. In some embodiments of the invention, there may be more than one individual located in an indoor location. According to at least one embodiment, one or more wearable IoT devices 123 may be registered to each individual in an indoor location.

Additionally, the program 200 may comprise a profile for each individual with their device exception list and device interaction history. As previously stated, a device exception list may comprise one or more exception devices, which can be devices 114 that the individual has designated to always provide power to, such as a router, or to provide power for a certain amount of time, such as a heat lamp in a pet's cage. An individual may indicate exception devices through the GUI of the program 200 by marking them on a list of devices 114 in the indoor location, and may input an amount of time to provide power to a device 114, a range of time to provide power to a device 114, or to always provide power to a device 114. Additionally, as previously stated, an individual's interaction history may comprise IoT loggings indicating an individual's presence. IoT loggings may comprise event data of an individual's interaction with a device 114, such as the volume button being pressed on a TV remote, or a file being transferred from a mobile device 101 to another device 114. The IoT loggings may be stored in the database 130. Additionally, interaction thresholds may be set on certain devices 114 on a time basis to determine if the individual interacts with the device 114 enough to require a constant flow of electricity. If an interaction threshold with a device 114 is reached, the program 200 may determine that the individual has a significant interaction history with the device 114. For example, if no IoT events are registered within a thirty (30) minute period, the program 200 may determine that the device 114 no longer requires electricity.

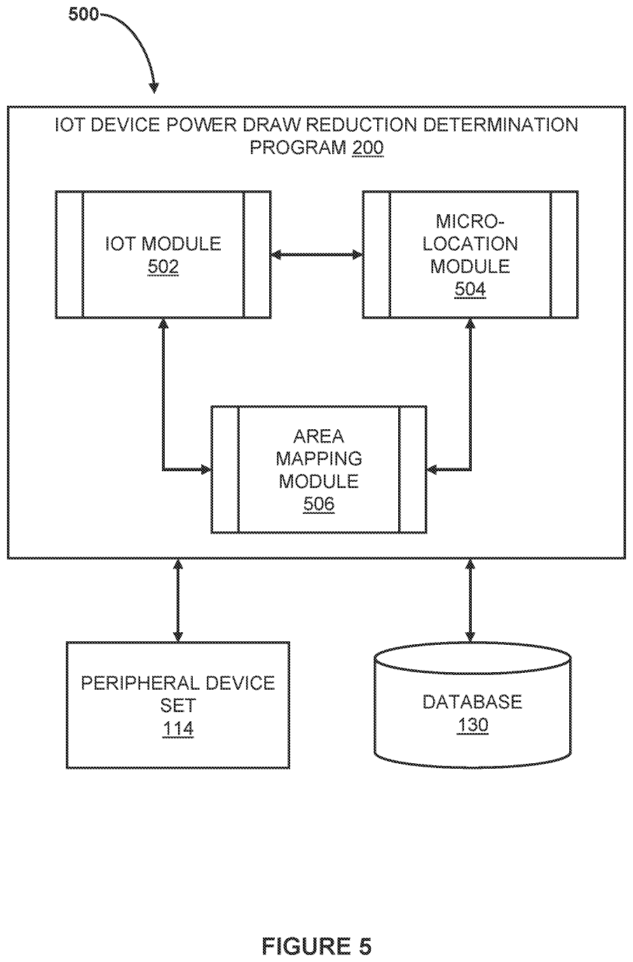

Additionally, in at least one embodiment, the program 200 may establish area, locational, and positional awareness. Area awareness may comprise learning the layout of an indoor location through room mapping techniques, such as predefining a room, or by using a camera-based mapping system, for example, using augmented reality, 3D scanners, and/or cameras, to combine images with data provided through various sensors 125, i.e., measured distances between obstacles, to build a layout of the indoor location. The program 200 may create a virtual 3D model of an indoor location using the area mapping module 506 (FIG. 5). The virtual 3D model of the indoor location may be stored in the database 130. By learning the layout of an indoor location, the program 200 can determine the micro-locations comprising each area of the indoor location. An area may comprise a section/space/zone of an indoor location, such as a room. Locational awareness may comprise determining the location of the devices 114 comprised within each area of an indoor location based on the micro-locations of the devices 114 or by the individual indicating what room a device 114 is in through the GUI of the program 200. The program 200 may receive data comprising the micro-location of a device 114 from the device 114 in the same way as the program 200 receives data comprising the micro-location of an individual from the one or more wearable IoT devices 123. Positional awareness may comprise iteratively detecting the location of the individuals in the indoor location. The program 200 can continuously receive the individual's location data from the wearable IoT devices 123 as the individual moves around the indoor location. The program 200 can analyze the incoming location data to dynamically determine an individual's micro-location in the indoor location.

At 204, the program 200 determines whether the individual entered a new area of the indoor location. The program 200 may determine that an individual has entered a new area based on a change in the individual's micro-location in the indoor location. As previously stated, the program 200 can continuously receive the individual's location data from the wearable IoT devices 123 as the individual moves around the indoor location. The program 200 can analyze the incoming location data using the micro-location module 504 (FIG. 5) to dynamically determine an individual's micro-location in the indoor location. Thus, upon determining that an individual's micro-location matches the micro-location(s) within a new area of the indoor location, the program 200 can determine that the individual is located within a newly entered area of the indoor location. According to one implementation, in response to determining that the individual entered a new area of the indoor location (step 204 “YES” branch), the program 200 may continue to step 206 to enter intelligent power management mode to analyze the individual's current micro-location, the individual's device interaction history, and the individual's device exception list. In response to determining that the individual did not enter a new area of the indoor location (step 204, “NO” branch), the program 200 may continue to continuously analyze the individual's micro-location to dynamically pinpoint the precise location of the individual under step 202.

At 206, the program 200 enters intelligent power management mode to analyze the individual's current micro-location, the individual's device interaction history, and the individual's device exception list. The program 200 can enter intelligent power management mode upon the flipping of a Boolean expression, specifically, an else statement. For example, the Boolean expression may comprise “If intelligent_power_management_mode==true; {execute dynamic power management based on defined constraints} ELSE {execute static predefined power management logic}”. The Boolean expression may be flipped upon a number of rules, such as rules related to predefined logic assigned by an individual, or recognized activity, such as the determination that the individual is located within a newly entered area of the indoor location. Upon the determination of an individual entering a new area of the indoor location, as described in step 204 above, the program 200 can enter an intelligent power management mode in which the program 200 can determine which areas and devices 114 within the indoor location require and do not require electricity by analyzing three sets of data. As previously stated, the program 200 can analyze an individual's current micro-location, the individual's device interaction history, and the individual's device exception list using machine learning models, such as an artificial neural network, and more specifically a recurrent neural network (“RNN”). Additionally, the program 200 can flag devices 114 on an individual's device exception list and devices 114 that are determined to have a significant interaction history with the individual, to indicate that the program 200 may bypass those device(s) 114 while issuing shut-off commands.

The RNN can be trained using training data that can be uploaded to the program 200, such as on manual classifications of device interactions. Manual classification of device interactions may comprise IoT device interactions, such as an individual increasing the volume on a TV, changing the channel of the TV, turning on a fan, dimming a light, etc. Additionally, the RNN can be trained on data comprising a steady state of no individual interaction, or standard behavior of the IoT event logs. The event log information stream or activity history of an IoT device can be captured and the RNN can be trained during specific time ranges, such as when an individual is not present in the indoor location. The IoT device interactions and standard events, such as when an individual is present in the indoor location, can be processed and compared with the RNN-trained events during which the individual is not present in the indoor location. The program 200 can use the trained RNN to dynamically process the captured data from devices 114, and 123, and to dynamically analyze the individual's current micro-location, the individual's interaction history, and the individual's device exception list, to determine if the flow of electricity to one or more devices 114 in the indoor location may be turned on or turned off. The analysis can comprise determining what area of an indoor location the individual is located in based on the individual's current micro-location, the devices 114 located within the area of the indoor location that need to be provided with electricity, the devices 114 located in the non-individual present areas of the indoor location that no longer need to be provided with electricity, and the devices 114 to flag as bypassing shut-off commands based on the individual's device exception list and the individual's significant interaction history. The program 200 may update, for example, daily, the RNN with analyzed data upon the collection and analysis of the data. The analyzed data may be stored in the database 130.

At 208, the program 200 provides command(s) to manage the flow of electricity to one or more IoT devices 114 in one or more non-individual present areas, and one or more IoT devices 114 in the newly entered area of the indoor location, based on the individual's analyzed current micro-location, analyzed device interaction history, and analyzed device exception list. The program 200 can control the flow of electricity through each area in the indoor location by connecting to one or more intermediary devices 114, such as an intelligent circuit breaker or a smart power strip, in the indoor location through LAN or WAN 102. IoT devices 114 can be connected to a smart power strip through electrical wires. An intelligent circuit breaker 114 may be connected to the areas in an indoor location through electrical wires. As previously stated, a command may comprise either a “power-off” or a “power-on” signal to one or more intermediary devices 114. The program 200 can turn off the flow of electricity to one or more IoT devices 114 by providing an auto-shut command to the one or more intermediary devices 114 to which the IoT devices 114 are connected. The program 200 can turn on the flow of electricity to one or more IoT devices 114 by providing an auto turn-on command to the one or more intermediary devices 114 to which the IoT devices 114 are connected. The program 200 can send commands via one or more cloud-based services, such as the API of the intermediary device 114. In at least one embodiment, the auto shut-off command may be sent through an API call, such as Resideo ProSeries Panel API, to a centralized device 114, to stop electricity flow to one or more IoT devices 114. Additionally, the individual may initiate a shut-off/turn-on command by pressing a prompt on the GUI of the individual's computer 101 or wearable IoT device 123. The program 200 may send a shut-off/turn-on command to one or more intermediary devices 114 based on the IoT device(s) 114 that the individual selected.

According to at least one embodiment, an area-by-area breakdown may be provided to an individual detailing the devices 114 in each area and the amount of electricity each device 114 is drawing during a certain period, such as every week, or every month. Additionally, the individual may view levels of energy consumption specific to each room. An individual may upload data to the program 200 indicating energy usage, such as information from an energy bill. The program 200 may display the breakdown on the GUI of the computer 101.

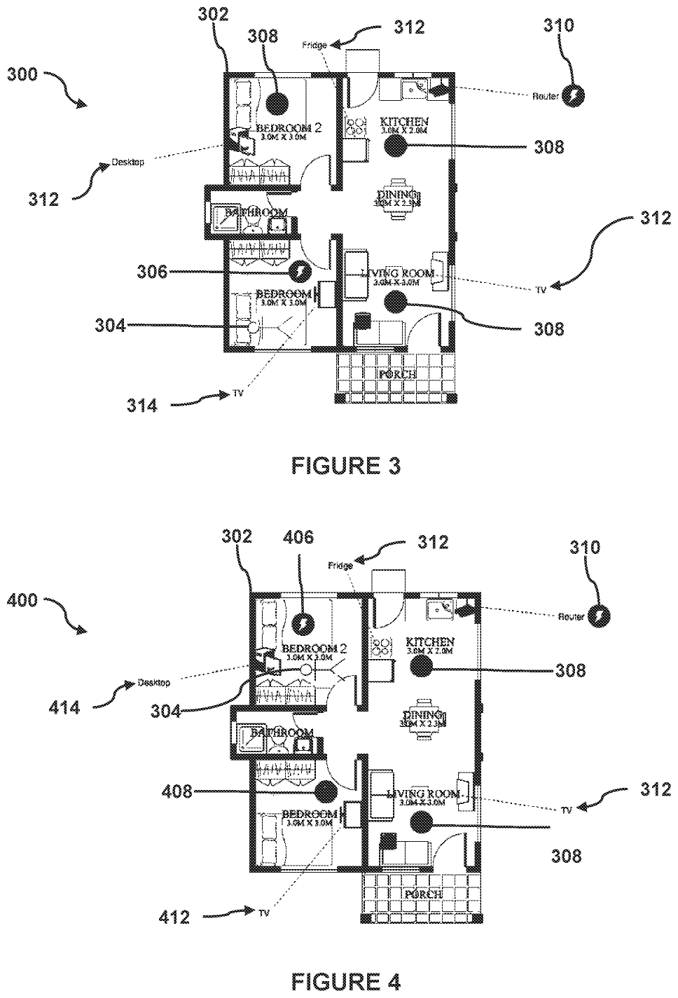

Referring now to FIG. 3, an illustration 300 of a power draw reduction process based on an individual's first micro-location in an indoor location is depicted according to at least one embodiment. An indoor location 302, specifically, an apartment, with multiple areas, such as rooms 306, 308, 308, and 308, multiple IoT devices, 310, 312, 312, 312, and 314, is depicted. Individual 304 is located inside bedroom 306, and thus, bedroom 306 is currently receiving electricity, such that all devices, for example, TV 314, comprised within bedroom 306, are powered on. The other rooms in the indoor location, such as bedroom two (2) 306, kitchen 306, and living room 306 are not receiving electricity based on being located within non-individual 304 present areas. Thus, devices such as TV 312, desktop 312, and refrigerator 312, in the non-individual 304 present areas 308, 308, and 308, are not receiving power. However, router 310 is either listed within the individual's 304 device exception list. Therefore, router 310 will always be receiving electricity regardless of the individual's 304 micro-location in the indoor location 302.

Referring now to FIG. 4, an illustration 400 of an updated power draw reduction process based on the individual's change in micro-location in the indoor location is depicted according to at least one embodiment. The individual 304 has now relocated to a different area, bedroom two (2) 406, from bedroom 408, in the indoor location 302. Upon the individual 304 entering bedroom two (2) 406, the program 200 sends an auto shut-off command to an IoT device (not pictured) in bedroom 306, and an auto turn-on command to an IoT device (not pictured) in bedroom two (2). Thus, bedroom two (2) 406, is now receiving electricity, such that all devices, for example, desktop 414, comprised within bedroom two (2) 406, are now powered on. Devices, such as TV 312 and refrigerator 312, in the non-individual 304 present areas 308 and 308, are not receiving power based on being located within non-individual 304 present areas. Additionally, bedroom 408, is now a non-present room and thus, no longer is receiving electricity. As a result, devices, for example, TV 412, in bedroom 408 are no longer receiving electricity to mitigate power usage from the phantom power draw of the devices. Additionally, as explained in the discussion of FIG. 3, router 310, as an exception device, is still receiving electricity.

Referring now to FIG. 5, a system diagram illustrating an exemplary program environment 500 of an implementation of an IoT device power draw reduction determination process 201 is depicted according to at least one embodiment. Here, the program 200 comprises an IoT module 502, a micro-location module 504, and an area mapping module 506. The exemplary program environment 500 details the interactions between the IoT module 502 and the micro-location module 504, the IoT module 502 and the area mapping module 506, and the micro-location module 504 and the area mapping module 506. Additionally, the exemplary program environment 500 details the interactions between the program 200 and the peripheral device set 114, and the program 200 and the database 130.

The IoT module 502 may be used to communicate with the peripheral device set 114, and more specifically, to send command(s) to manage the flow of electricity to one or more peripheral device(s) 114. The micro-location module 504 may be used to dynamically track an individual's micro-location. The area mapping module 506 may be used to perform room mapping techniques and build a virtual 3D model of a location.

It may be appreciated that FIGS. 2 through 5 provide only an illustration of one implementation and do not imply any limitations with regard to how different embodiments may be implemented. Many modifications to the depicted environments may be made based on design and implementation requirements.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A processor-implemented method for managing power draw reduction of one or more IoT devices, the method comprising:
determining, continuously, an individual's micro-location to dynamically pinpoint a location of the individual in an indoor location using one or more wearable IoT devices;
determining if the individual has entered a new area of the indoor location;
upon determining that the individual has entered the new area of the indoor location, analyzing the individual's current micro-location, device interaction history, and device exception list;
providing one or more commands to one or more IoT devices in one or more non-individually present areas to manage electricity flow to the one or more IoT devices; and
providing one or more commands to one or more IoT devices in the newly entered area of the indoor location to manage electricity flow to the one or more IoT devices.

2. The method of claim 1, wherein providing the one or more commands to the one or more IoT devices to manage the electricity flow to the one or more IoT devices comprises sending an auto shut-off command and/or a turn-on command via one or more cloud-based services.

3. The method of claim 1, wherein analyzing the individual's current micro-location, device interaction history, and device exception list comprises entering an intelligent power management mode upon a flipping of a Boolean expression.

4. The method of claim 1, wherein the one or more commands to the one or more IoT devices in the one or more non-individually present areas and the one or more IoT devices in the newly entered area of the indoor location are based upon the analyzed individual's current micro-location, device interaction history, and device exception list.

5. The method of claim 1, further comprising:
providing one or more commands to the one or more IoT devices in the indoor location, to manage the electricity flow of the one or more IoT devices, is based on one or more individuals' current micro-location, one or more individuals' device interaction history, and one or more individuals' device exception list.

6. The method of claim 1, wherein analyzing the individual's current micro-location, the device interaction history, and the device exception list, comprises training and using a recurrent neural network.

7. The method of claim 1, wherein the managing of electricity flow to the one or more IoT devices comprises connecting to one or more intermediary devices.

8. A computer system for managing power draw reduction of one or more IoT devices, the computer system comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
determining, continuously, an individual's micro-location to dynamically pinpoint a location of the individual in an indoor location using one or more wearable IoT devices;
determining if the individual has entered a new area of the indoor location;
upon determining that the individual has entered the new area of the indoor location, analyzing the individual's current micro-location, device interaction history, and device exception list;
providing one or more commands to one or more IoT devices in one or more non-individually present areas to manage electricity flow to the one or more IoT devices; and
providing one or more commands to one or more IoT devices in the newly entered area of the indoor location to manage electricity flow to the one or more IoT devices.

9. The computer system of claim 8, wherein providing the one or more commands to the one or more IoT devices to manage the electricity flow to the one or more IoT devices comprises sending an auto shut-off command and/or a turn-on command via one or more cloud-based services.

10. The computer system of claim 8, wherein analyzing the individual's current micro-location, device interaction history, and device exception list comprises entering an intelligent power management mode upon a flipping of a Boolean expression.

11. The computer system of claim 8, wherein the one or more commands to the one or more IoT devices in the one or more non-individually present areas and the one or more IoT devices in the newly entered area of the indoor location are based upon the analyzed individual's current micro-location, device interaction history, and device exception list.

12. The computer system of claim 8, further comprising:
providing one or more commands to the one or more IoT devices in the indoor location, to manage the electricity flow of the one or more IoT devices, is based on one or more individuals' current micro-location, one or more individuals' device interaction history, and one or more individuals' device exception list.

13. The computer system of claim 8, wherein analyzing the individual's current micro-location, the device interaction history, and the device exception list, comprises training and using a recurrent neural network.

14. The computer system of claim 8, wherein the managing of electricity flow to the one or more IoT devices comprises connecting to one or more intermediary devices.

15. A computer program product for managing power draw reduction of one or more IoT devices, the computer program product comprising:
one or more computer-readable tangible storage medium and program instructions stored on at least one of the one or more tangible storage medium, the program instructions executable by a processor to cause the processor to perform a method comprising:
determining, continuously, an individual's micro-location to dynamically pinpoint a location of the individual in an indoor location using one or more wearable IoT devices;
determining if the individual has entered a new area of the indoor location;
upon determining that the individual has entered the new area of the indoor location, analyzing the individual's current micro-location, device interaction history, and device exception list;
providing one or more commands to one or more IoT devices in one or more non-individually present areas to manage electricity flow to the one or more IoT devices; and
providing one or more commands to one or more IoT devices in the newly entered area of the indoor location to manage electricity flow to the one or more IoT devices.

16. The computer program product of claim 15, wherein providing the one or more commands to the one or more IoT devices to manage the electricity flow to the one or more IoT devices comprises sending an auto shut-off command and/or a turn-on command via one or more cloud-based services.

17. The computer program product of claim 15, wherein analyzing the individual's current micro-location, device interaction history, and device exception list comprises entering an intelligent power management mode upon a flipping of a Boolean expression.

18. The computer program product of claim 15, wherein the one or more commands to the one or more IoT devices in the one or more non-individually present areas and the one or more IoT devices in the newly entered area of the indoor location are based upon the analyzed individual's current micro-location, device interaction history, and device exception list.

19. The computer program product of claim 15, further comprising:
providing one or more commands to the one or more IoT devices in the indoor location, to manage the electricity flow of the one or more IoT devices, is based on one or more individuals' current micro-location, one or more individuals' device interaction history, and one or more individuals' device exception list.

20. The computer program product of claim 15, wherein analyzing the individual's current micro-location, the device interaction history, and the device exception list, comprises training and using a recurrent neural network.
